(19) United States
(12) Patent Application Publication
(10) Pub. No.: US 2007/0272883 A1
(43) Pub. Date: Nov. 29, 2007

(54) METHOD AND APPARATUS FOR WEB TEAR MONITORING OF A MATERIAL WEB

(76) Inventors: Patrick Hennes, Bolheim (DE); Werner Buttschardt, Herbrechtingen (DE)

Correspondence Address: TAYLOR & AUST, P.C., P.O. Box 560, 142. S Main Street, Avilla, IN, 46710, US

(21) Appl. No.: 11/748,725

(22) Filed: May 15, 2007

(30) Foreign Application Priority Data
May 24, 2006 (DE) 10 2006 024 344.7

(51) Int. Cl. G01N 21/88

(52) U.S. Cl. 250/559.45

(57) ABSTRACT

This invention relates to a method for web tear monitoring on a machine used for the production and/or treatment of a fiber material web, in particular a paper web or paperboard web, said machine being in particular a paper machine or coating machine on which the fiber material web is conveyed at a defined speed in its longitudinal direction along a defined path, wherein a web tear is detected by way of a light-emitting component and a light-receiving sensor in that light is emitted from the light-emitting component in the direction of the fiber material web to a defined target point and, given the presence of the fiber material web, is reflected and/or let through and/or directed in the target point to the light-receiving sensor. The light is emitted, either by a multiplicity of light-emitting components arranged side by side on a first side of the fiber material web or by one light-emitting component with a linear light source on the first side, in the direction of an assigned multiplicity of light-receiving sensors arranged side by side on a second side of the fiber material web opposite the first side such that a light array extending in the transverse direction of the fiber material web and over its entire width is formed.

### BACKGROUND OF THE INVENTION

1. Field of the Invention

This invention relates to a method and an apparatus for web tear monitoring on a machine used for the production and/or treatment of a fiber material web, in particular a paper web or paperboard web, said machine being in particular a paper machine or coating machine on which the fiber material web is conveyed at a defined, usually constant speed in its longitudinal direction along a defined path.

2. Description of the Related Art

Methods and apparatuses for web tear monitoring are known in various versions. For example, attention is drawn to the German publications of unexamined application DE 101 57 914 A1 and DE 101 57 915 A1 in which it is proposed to determine the tearing of a paper web by detecting the web speed or the web draw.

Furthermore, the German publication of unexamined application DE 42 16 653 A1 describes an apparatus for severing a paper web in a press section of a paper machine, on which apparatus provision is made for a tear detector with a send/receive unit such that, through a comparison of the color tone of the dryer felt of the current tear with a previous measurement value, said detector activates a cut-off apparatus when the color comparison reveals a conformance.

Finally, U.S. Pat. No. 5,289,007 discloses a web tear detection apparatus which works with components, namely an infrared transmitter and an infrared receiver, arranged on opposite sides of the web.

The methods and apparatuses according to the prior art work either with reflected radiation detected by sensors or only point-focally. On the one hand use is made in this case of complex and vulnerable sensors which do not always work reliably in certain applications, in particular at very high web speeds. On the other hand it has turned out in practice that often a web tear can only be detected reliably and quickly enough when a total web tear has occurred.

What is needed in the art is a method and an apparatus for web tear monitoring which compared to the prior art are improved and result in particular in a more reliable and quicker detection of web tears, including partial tears, and advantageously structural surface defects.

### SUMMARY OF THE INVENTION

According to the present invention, it is possible to monitor the fiber material web, in particular a paper web, reliably over the entire machine width and in particular independently of the web speed. A tear, including a partial tear, can thus be detected more quickly than is possible with point-focal monitoring of the paper web for example. Even if the material web splits lengthwise, this can be reliably detected by the inventive embodiment.

Finally, it is possible to detect even single holes in the web and in particular any sagging of the web so that it is possible in the ideal case to determine when a tear is imminent although it has not yet begun.

The basic idea behind the present invention can be summarized in that instead of a single point of the fiber material web being monitored, a light array is radiated onto or, according to one embodiment of the invention, continuously through the fiber material web, said array being detected by provision of a corresponding number of light-receiving sensors arranged side by side, thus enabling the condition of the fiber material web to be assessed over its entire web width.

If the intensity of the light from the light-emitting components is adjusted in accordance with the light transmission of the material web such that the assigned light-receiving sensors always receive the emitted light, then it is possible to determine from the intensity of the received light whether the material web is present or which density the material web has at the target point at which the ray of light from the corresponding light-emitting component penetrates the material web. It is also possible to determine whether the light ray was radiated through the material web more than once. Given the opposing arrangement of transmitters and receivers of an individual light ray on opposite sides of the material web according to the present invention, a double passage is only possible when the material web sags in the direction of its longitudinal axis or, in the case of light rays radiated through in an acute angle to the longitudinal axis of the material web, also in the direction of its transverse axis. Such sagging is unwelcome, and by detecting the sagging the present invention enables suitable action to be taken .

If the intensity of the received light ray rises above a defined limit value for example, then it is clear that either no material web was present at the corresponding target point or the density or gsm substance of the material web is too low. Too low a density can be the germinating bed for an incipient tear. Hence it is possible in accordance with the present invention to detect tears even before they occur in the form of actual openings or tear lines.

In detail the inventive method for web tear monitoring on a machine used for the production and/or treatment of a material web, in particular a paper web or paperboard web, said machine being in particular a paper machine or coating machine on which the material web is conveyed at a defined speed in its longitudinal direction along a defined path. A web tear is detected by way of a light-emitting component and a light-receiving sensor in that light is emitted from the light-emitting component in the direction of the material web to a defined target point and, given the presence of the material web, is reflected and/or let through and/or directed in the target point to the light-receiving sensor. The light is emitted, either with a multiplicity of light-emitting components arranged side by side on a first side of the material web or with one component in the form of a linear light source on the first side, in the direction of an assigned multiplicity of light-receiving sensors arranged side by side. In this case the light-receiving sensors are arranged on a second side of the material web, said second side being positioned opposite the first side. In other words, the light-emitting components and the light-receiving sensors are arranged on different sides of the material web such that they enclose the material web in between.

By way of the light-emitting component or the multiplicity of light-emitting components arranged side by side, a light array is emitted in the direction of the assigned multiplicity of light-receiving sensors extending fully in the transverse direction of the material web over its entire width. In the context of the current invention, the “entire width” means the entire extension from the first lateral edge of the material web to its second lateral edge. However, it is not detrimental in particular if individual regions of the material web, in particular at its outermost lateral edges, are not fully covered by the light array. The important thing is for essentially the entire width of the material web to be covered in the transverse direction. According to an advantageous embodiment of the invention, however, the light array extends over the entire width of the material web in the transverse direction.

When the material web is conveyed horizontally it is possible, for example, for the light-emitting component or light-emitting components to be arranged above the material web and for the light-receiving sensors to be arranged below the material web or vice versa. In this case the light-emitting component or light-emitting components and the light-receiving sensors each have in particular at least or exactly the width of the material web in the transverse direction, meaning from lateral edge to lateral edge. To reduce the width of the light-emitting components, which are arranged side by side and advantageously joined together or integrated to form a single transmitter rail, and the width of the light-receiving sensors, which likewise are advantageously joined together or integrated to form a single rail, namely a receiver rail, the light-emitting components and the light-receiving sensors are advantageously arranged such that the light array is radiated at an acute angle onto one of the two broad sides of the material web, meaning onto the top side or the bottom side of the material web in the horizontal arrangement described.

The light-emitting components or the linear light-emitting component and accordingly in particular also the assigned light-receiving sensors are advantageously constructed such that the light array forms a line, in particular a dotted line, on the material web when it strikes thereon. The line can extend in this case perpendicular to the lateral edges of the material web or at an angle thereto. In particular the line extends over and across the entire width of the material web.

If provision is made for a multiplicity of light-emitting components, then it is preferable for exactly one light-emitting component to be assigned to each light-receiving component. The assigned light-emitting component emits a single, in particular bundled ray of light to the light-receiving sensor. For example, each light-emitting component can be constructed in the form of a single diode and each light-receiving sensor likewise in the form of a single diode. The light-emitting components are then accordingly transmitter diodes and the light-receiving sensors are receiver diodes.

In particular in the case of the previously described embodiment it can be an advantage to assign to the multiplicity of light-receiving sensors, in particular the receiver diodes, by way of an assigned control device, a recognition pattern which stipulates for each light-receiving sensor a light intensity limit value which is compared with the light intensity actually detected by the light-receiving sensor. In this case a so-called black-and-white comparison is not the only possibility, meaning that it is not necessarily only a case of deciding whether light from the assigned light-emitting component arrives in the light-receiving sensor in order thus to determine whether a non-transparent material web is in the light path and blocking off the light from the transmitter, but that it is also possible to adjust the light source of the light-emitting component according to the transparency of the material web such that light always reaches the assigned light-receiving sensor at least with a residual intensity. In the context of the current invention, “always” means either an uninterrupted light-conducting connection between a transmitter and a receiver or an essentially uninterrupted connection.

On the basis of the comparison of the actually detected light intensity with the defined light intensity from the recognition pattern it is possible to determine whether the material web has the desired property at the target point assigned to the light-emitting component, meaning it is possible to determine whether a part of the material web is present at this target point or whether the material web has the desired condition, in particular density, in this target point or whether the formation of a tear has already begun or is imminent.

For example, a material web which was already unacceptably stretched can let through more light in the target point than is desirable, and this can be determined according to the present invention through a comparison with the recognition pattern. By providing a light array it is possible to detect even individual holes or weak-points in the material web which do not exist or do not yet exist over the entire width of the material web.

In particular, on the basis of the comparison a warning can be issued or safety actions taken, for example actuating at least one web cut-off apparatus, stopping the ink supply, throwing off or opening the doctor blade holders and/or roller nips, or throttling the dryer power. In general it is possible, in order to protect persons from injury and equipment from damage, for those units which are assigned to the machine, for example dryer units or coating units, to be transferred from a working position into a waiting position, for example by throwing off or shifting, and/or to be lowered in performance or switched off, and for those media which are supplied to the machine, for example water, steam or ink, to be reduced in quantity or shut off. Needless to say, other actions are also possible.

It is particularly advantageous to provide a control device which enables the recognition pattern to be programmed, for example on the basis of the material web properties. According to a programming method, a recognition pattern is automatically created on the basis of material web properties which are entered and in particular asked for at an input terminal, in particular in connection with the entered gsm substance and/or the defined use.

The apparatus of the invention has, in reflection of the features of the described method, a (single) light-emitting component with a linear light source or a multiplicity of light-emitting components arranged side by side. The component or components are arranged on a first side of the material web. Arranged on a second side, which lies opposite the first side, is a multiplicity of light-receiving sensors which are assigned to the light-emitting component or light-emitting components such that the light which is emitted from the light-emitting component or light-emitting components in the direction of the assigned light-receiving sensors forms a light array which extends in the transverse direction of the material web and over and across its entire width while said material web is transported along its longitudinal direction.

In particular if the light-emitting components and the light-receiving sensors are constructed in the form of a transmitter rail and a receiver rail, wherein both rails are constructed advantageously in a single piece, for example through integration or mounting of the above described diodes, then the light array can be constructed in the form of a light strip of constant width which is composed advantageously of a multiplicity of parallel, bundled light rays.

The emitted light according to the invention has preferably a wave length in the visible range, in particular between 380 and 780 nanometers.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows an inventive apparatus arranged at an angle to a material web; and

FIG. 2 shows schematically the possible construction of the light-emitting components and light-receiving sensors in the form of a transmitter rail and a receiver rail such as they can be used on the embodiment in FIG. 1 for example.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

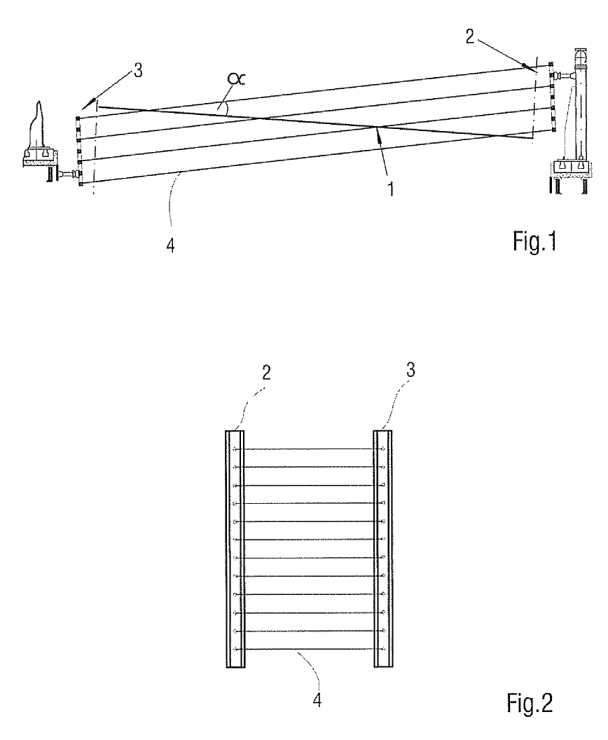

Referring now to the drawings, and more particularly to FIG. 1, there is shown a fiber material web 1, for example a paper web, which is moved horizontally in a corresponding machine, for example a paper machine (only two supports to the right and left of the paper web 1 are shown in extracts), in its longitudinal direction. The machine part can be a drying section or a part of a coating machine.

Using a multiplicity of light-emitting components 2 in the form of a transmitter rail which is arranged above the material web 1, a light array 4 is emitted obliquely downward through the material web 1 or through defect points or tear points therein to a multiplicity of light-receiving sensors 3, wherein the latter are constructed likewise in the form of a rail, namely a receiver rail, and arranged underneath the material web 1.

Owing to the acute angle a selected for the angle at which the light array 4 or the individual mutually parallel light rays, of which four are indicated here schematically, strike the material web 1, primarily on its surface, it is possible to construct the longitudinal extension of the transmitter rail and the receiver rail smaller by a multiple relative to the width of the material web 1. As can be seen, the light array 4, which in a lateral plan view has the form of a rectangle, nearly or completely covers the entire width in the transverse direction of the material web 1.

Alternatively it would be possible, of course, for the light-emitting components 2 or transmitter rail to be arranged horizontally above or below the material web 1 and then advantageously constructed with the same width as the material web 1, and for the light-receiving sensors 3 or receiver rail to be arranged in a corresponding embodiment on the opposite side.

Visible in FIG. 2 in somewhat greater detail are the light-emitting components 2 and light-receiving sensors 3 constructed in the form of rails. As can be seen, the transmitter rail includes a multiplicity of light-emitting components, for example transmitter diodes, which are arranged in regular intervals and aligned with each other in the longitudinal direction of the rail. The receiver rail has a construction which corresponds to the transmitter rail except that in place of each individual transmitter diode provision is made for a receiver diode as the light-receiving sensor.

Accordingly, the light array 4 is constructed by a multiplicity of parallel, bundled light rays which correspond in their number respectively to the number of light-emitting components 2 or transmitter diodes and light-receiving sensors 3 or receiver diodes.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for web tear monitoring on a machine used for at least one of the production and treatment of a fiber material web, the machine being one of a paper machine and a coating machine on which the fiber material web is conveyed at a defined speed in a longitudinal direction of the fiber material web along a defined path, said method comprising the steps of:
detecting a web tear using at least one light-emitting component and at least one light-receiving sensor; and
emitting light from said at least one light-emitting component in a direction of the fiber material web to a defined target point such that, given a presence of the fiber material web, light is at least one of reflected, let through, and directed in said target point to said at least one light-receiving sensor, said light being emitted, one of by a plurality of said light-emitting components arranged side-by-side on a first side of the material web and by one light-emitting component with a linear light source on said first side, in a direction of an assigned plurality of said light-receiving sensors arranged side-by-side on a second side of the material web opposite said first side such that a light array extending in a transverse direction of the fiber material web and over an entire width of the fiber material web is formed.

2. The method according to claim 1, wherein said light array is emitted at an acute angle onto one of two broad sides of the fiber material web.

3. The method according to claim 1, wherein said light array is emitted such that said light array forms, on a non-torn material web, a line extending perpendicular to a plurality of lateral edges of the fiber material web and over said entire width of the fiber material web.

4. The method according to claim 1, further comprising assigning to each said light-receiving sensor exactly one said light-emitting component which emits a light ray in a direction of said light-receiving sensor.

5. The method according to claim 4, wherein said light ray is a bundled light ray.

6. The method according to claim 4, further comprising assigning to said plurality of light-receiving sensors a recognition pattern which stipulates for each said light-receiving sensor a light intensity limit value which is compared with a light intensity actually detected by said light-receiving sensor, on the basis of which at least one of comparison warnings are issued and safety actions are taken on the machine.

7. The method according to claim 6, wherein said recognition pattern is programmed, using a control device, on the basis of a plurality of material web properties.

8. The method according to claim 7, wherein said recognition pattern is created automatically on the basis of entered said plurality of material web properties.

9. The method according to claim 8, wherein said entered plurality of material web properties includes at least one of a gsm substance and an intended use of the fiber material web.

10. The method according to claim 8, wherein said intensity of said light from one of said light-emitting component and said plurality of light-emitting components is adjusted in accordance with a light transmission of the fiber material web such that said assigned plurality of light-receiving sensors one of always and essentially always receives said emitted light with a result that said intensity of received said light is lower at least one of when there is material web in respective said target point assigned to respective said light-emitting component, according to a number of light passages through the fiber material web, and according to a density of the fiber material web than when no fiber material web is present.

11. An apparatus for web tear monitoring on a machine used for at least one of the production and treatment of a fiber material web, the machine being one of a paper machine and a coating machine on which the fiber material web is conveyed at a defined speed in a longitudinal direction of the fiber material web along a defined path, said apparatus comprising:
at least one light-emitting component including one of one light-emitting component with a linear light source on a first side of the fiber material web and a plurality of said light-emitting components arranged side-by-side on said first side; and
at least one light-receiving sensor which is assigned to said at least one light-emitting component in that light from said at least one light-emitting component is emitted in a direction of a defined target point and, given a presence of the fiber material web, is at least one of reflected, let through, and directed in said target point to said at least one light-receiving sensor, said at least one light-receiving sensor including a plurality of said light-receiving sensors which are positioned side-by-side on a second side of the fiber material web opposite said first side, said plurality of light-receiving sensors being assigned to one of said light-emitting component and said plurality of light-emitting components such that said light which is emitted from one of said light-emitting component and said plurality of light-emitting components in a direction of said assigned plurality of light-receiving sensors forms a light array extending in a transverse direction of the fiber material web and over an entire width of the fiber material web.

12. The apparatus according to claim 11, wherein one of said light-emitting component and said plurality of light-emitting components and said plurality of light-receiving sensors form a single-piece transmitter rail and a single-piece receiver rail, which oppose each other on opposite sides of the fiber material web such that a plurality of parallel light rays is emitted in the form of a grid-shaped light strip of constant width from said transmitter rail in a direction of said receiver rail.

13. The apparatus according to claim 12, wherein said plurality of parallel light rays are bundled light rays.

14. The apparatus according to claim 11, further comprising a control device connected to one of said light-emitting component and said plurality of light-emitting components and to said plurality of light-receiving sensors, said control device configured for controlling:
a detection of a web tear using said at least one light-emitting component and said at least one light-receiving sensor; and
an emission of light, one of by said plurality of light-emitting components arranged side-by-side on said first side of the fiber material web and by said one light-emitting component with said linear light source on said first side, in said direction of said assigned plurality of light-receiving sensors arranged side-by-side on said second side of the fiber material web opposite said first side such that said light array extending in said transverse direction of the fiber material web and over said entire width of the fiber material web is formed.

15. A machine which transports a fiber material web in a longitudinal direction thereof along a defined path, the machine being one of a paper machine and a coating machine, said machine comprising:
an apparatus for web tear monitoring including:
at least one light-emitting component including one of one light-emitting component with a linear light source on a first side of the fiber material web and a plurality of said light-emitting components arranged side-by-side on said first side; and
at least one light-receiving sensor which is assigned to said at least one light-emitting component in that light from said at least one light-emitting component is emitted in a direction of a defined target point and, given a presence of the fiber material web, is at least one of reflected, let through, and directed in said target point to said at least one light-receiving sensor, said at least one light-receiving sensor including a plurality of said light-receiving sensors which are positioned side-by-side on a second side of the fiber material web opposite said first side, said plurality of light-receiving sensors being assigned to one of said light-emitting component and said plurality of light-emitting components such that said light which is emitted from one of said light-emitting component and said plurality of light-emitting components in a direction of said assigned plurality of light-receiving sensors forms a light array extending in a transverse direction of the material web and over an entire width of the fiber material web, one of said light-emitting component and said plurality of light-emitting components and said plurality of light-receiving sensors being arranged at an angle in relation to a surface of the fiber material web such that said light array is emitted at an acute angle onto one of two broad sides of the fiber material web.
